(19) United States
(12) Patent Application Publication
(10) Pub. No.: US 2010/0292061 A1
(43) Pub. Date: Nov. 18, 2010

(54) CYLINDER AND/OR ROLLER AND A PROCESS FOR THE PRODUCTION OF A CYLINDER AND/OR ROLLER

(76) Inventors: Thomas Söntgen, Hamminkeln (DE); Sigrid Thanner, Hamminkeln (DE); Robert Wagner, Eckental (DE); Gerald Hohenbichler, Kronstorf (AT); Andreas Krös, Oberweis (AT)

Correspondence Address: King & Spalding LLP, 401 Congress Avenue, Suite 3200, Austin, TX, 78701, US

(21) Appl. No.: 12/527,657

(22) PCT Filed: Jun. 19, 2007
(86) PCT No.: PCT/EP2007/056057

§ 371 Date: Jan. 20, 2010

(30) Foreign Application Priority Data
Feb. 20, 2007 (DE) 10 2007 008 715.4

(51) Int. Cl. B05C 1/00; C25D 15/00; B32B 43/00; B05D 5/00; F16C 13/00

(52) U.S. Cl. 492/9; 205/109; 427/140; 427/256; 492/49

(57) ABSTRACT

in a cylinder and/or a roller and in a method for producing and/or for the maintenance of a cylinder and/or roller, a metal layer (8, 9, 10) is applied, at least in parts, to the outer surface (2) of the cylinder (1, 1″) and/or the roller (1′). The metal layer (8, 9, 10) has a ductile metallic matrix (4) having embedded hard material particles (5). Such a cylinder and/or roller can be used in a device (11) for controlling the wear and tear of a cylinder (1, 1″) and/or roller (1′), the surfaces (2′) of which are subjected to wear and tear. The method for producing the cylinder and/or roller, the cylinder and/or roller, and the device for controlling wear and tear, allow the maintenance, costs and labour of the cylinder and/or roller to be reduced.

### CROSS-REFERENCE TO RELATED APPLICATIONS

This application is a U.S. National Stage Application of International Application No. PCT/EP2007/056057 filed Jun. 19, 2007, which designates the United States of America, and claims priority to German Application No. 10 2007 008 715.4 filed Feb. 20, 2007, the contents of which are hereby incorporated by reference in their entirety.

### TECHNICAL FIELD

The invention relates to a cylinder and/or roller and to a device for monitoring the wear on a cylinder which is subjected to wear on its surface. In addition, the invention relates to a process for the production and/or repair of a cylinder and/or roller, wherein a metal layer is applied to at least portions of an outer surface of the cylinder and/or roller.

### BACKGROUND

Cylinders and/or rollers are used in many technological fields, for example in the paper industry, in the textile industry or in the metal industry for guiding and processing material.

By way of example, finished metal products such as sheet metal, plates, bar steel or wire are produced from metal precursor products, in particular steel, for example in the form of slabs, blooms or billets, in a steel and/or rolling mill. Cylinders, in particular working cylinders and back-up cylinders, are generally used when converting the metal precursor products into finished metal products. In this process, working cylinders are in direct contact with the metal to be processed and, particularly in hot rolling mills, are exposed to high thermal and mechanical loading.

Therefore, working cylinders in particular experience a high degree of wear in steel mills. Despite the high degree of wear and a thereby changing surface of the working cylinder, it is necessary for the working cylinders to allow the finished metal product to be produced with a desired quality. By way of example, a feature of quality may be the surface evenness of a finished metal product.

The wear phenomena which occur on the surface of the cylinder and/or roller result in changes to the surface of the cylinder and/or roller, and this influences the frictional conditions between individual cylinders or between a cylinder and the metal material processed by the cylinder. The coefficient of friction between a cylinder and/or roller and the metal material to be processed is, however, an important criterion for setting the quality of the finished metal product.

Similar wear processes also occur in the case of dressing cylinders which are likewise used in metal-processing industrial installations. Wear processes of this type also affect paper rollers, carpet rollers and many other rollers which are subjected to corresponding loading. Wear phenomena such as these are also significant for rollers that guide, process or transport material, for example deflection rollers or transport rollers. In particular, the surface of cylinders and rollers generally experiences a high degree of wear when processing products having a fibrous structure, such as paper or carpet fibers.

The prior art contains the following indications for reducing the wear on cylinders:

JP 01293911-A discloses a working cylinder which is intended for a hot rolling train and comprises a surface having a cermet coating, wherein the coating comprises WC, CrC₃, TiC: 60-95% by mass with one or more than two binder metals from the group consisting of Co, Ni, Cr.

JP 2002282909-A discloses a cylinder which is intended for a hot rolling train and comprises an outer layer which contains tungsten carbide particles and has a volumetric ratio of 50 to 80% by volume in a nickel-cobalt alloy, which is applied to an inner layer of the cylinder by centrifugal casting.

JP 2000160283 discloses a chemical composition of a cylinder surface which is composed of the following constituents (in mass percent—mp): 0.1 to 1.2 mp carbon; 0.1 to 2.5 mp silicon; 0.1 to 2.5 mp manganese; 1.0 to 5.0 mp chromium; 0.1 to 4.0 mp molybdenum; 0.1 to 5.0 mp vanadium; 0.1 to 5.0 mp cobalt; 0 to 7.3 mp niobium and 0 to 7.8 mp tungsten. The remaining constituent is defined mass percentages of iron containing tungsten and molybdenum.

The disadvantages of these coatings, which reduce the wear on cylinders, are that they are expensive to produce, that only a limited accuracy of the layer thickness can be achieved and that it is possible to set a production-process-related property of the layer—for example the porosity—only in a specific, disadvantageous range. In particular, the high contents of foreign substances in the metal layer can result in breaking points as a result of the accumulation of hard material particles. These breaking points are referred to as cracks and reduce the service life of the coating.

### SUMMARY

According to various embodiments, a cylinder and/or roller, a process for the production of a cylinder and/or roller and a device for monitoring wear can be specified which reduce the expenditure for repairing the cylinder and/or the roller.

According to an embodiment, a cylinder and/or roller may comprise an outer surface, wherein a metal layer is applied to at least portions of the outer surface, wherein the metal layer is in the form of a ductile metallic matrix having incorporated hard material particles.

According to a further embodiment, the hard material particles can be formed by an element from the group consisting of carbides, in particular boron carbide, tungsten carbide or silicon carbide, or aluminum titanate or carbon modifications, in particular diamond, carbon nanotubes or graphite, or zirconium oxide. According to a further embodiment, the ductile metallic matrix may contain nickel. According to a further embodiment, the ductile metallic matrix may contain cobalt. According to a further embodiment, hard material particles to be introduced into the metal layer may be covered with a coating. According to a further embodiment, the ductile metallic matrix may have a predefinable density distribution of incorporated hard material particles. According to a further embodiment, the ductile metallic matrix may have a mean volume density of incorporated hard material particles of substantially at most 40% by volume. According to a further embodiment, the ductile metallic matrix may have a predefinable grain size distribution of incorporated hard material particles. According to a further embodiment, a plurality of metal layers can be applied to the outer surface on top of one another, wherein adjoining metal layers have different colors. According to a further embodiment, colored particles can be incorporated in the ductile metallic matrix. According to a further embodiment, said cylinder may be in the form of a working cylinder, a back-up cylinder, a dressing cylinder or a guide roller, in particular a deflection roller.

According to another embodiment, in a process for the production and/or repair of a cylinder and/or roller, wherein a metal layer is applied to at least portions of an outer surface of the cylinder and/or roller, a ductile metallic matrix having incorporated hard material particles may be used as the metal layer.

According to a further embodiment, when the metal layer is being applied, the cylinder may be rotated about its axis of rotation in relation to means for applying the metal layer. According to a further embodiment, the ductile metallic matrix having the incorporated hard material particles may be applied by means of electrolysis.

According to yet another embodiment, a device for monitoring the wear on a cylinder and/or roller as described above, which is subjected to wear on its surface, may comprise a detector for detecting a change in color on the surface.

According to a further embodiment, the detector may detect the color of the metal layer. According to a further embodiment, the device may comprise a device for emitting a signal at least when a change in color has been detected. According to a further embodiment, the device may comprise a monitoring control center to which the signal can be supplied.

### BRIEF DESCRIPTION OF THE DRAWINGS

Further advantages of the invention emerge from exemplary embodiments which are explained in more detail on the basis of the schematically illustrated drawings which follow, in which:

FIG. 1 shows an electrolysis device for applying a metal layer to a cylinder,

FIG. 2 shows an excerpt from the side of a cylinder coated with a metal layer,

FIG. 3 shows a cylinder coated with a plurality of colored metal layers,

FIG. 4 shows a device for monitoring the wear on a cylinder of a roll stand of a rolling train,

FIG. 5 shows a device for monitoring the wear on guide rollers of a casting installation, and

FIG. 6 shows a flowchart to schematically illustrate a sequence of a production process according to an embodiment.

### DETAILED DESCRIPTION

In terms of the device, the object is achieved by means of a cylinder and/or roller with an outer surface, wherein a metal layer is applied to at least portions of the outer surface and the metal layer is in the form of a ductile metallic matrix having incorporated hard material particles.

A ductile metallic matrix is understood to mean a metal which predefines a structure for incorporating the hard material particles. By contrast with the prior art, it is accordingly necessary for the metal content to comprise substantially at least 50% by volume of the metal layer. In this case, more ductile denotes a relatively soft metallic base material having a Vickers hardness of at most about 180-230 HV₀₁. The Vickers hardness is determined in accordance with the standard DIN EN ISO 6507.

Since a ductile metallic matrix is used, there is also no material separation, in particular the accumulated precipitation of hard material particles, over time owing to the pressure exerted on the cylinder and/or roller. The ductile matrix preferably surrounds each hard material particle in such a way that no two hard material particles come into direct contact. This prevents predetermined breaking points. The properties of the coating therefore remain stable even under loading for relatively long periods of time.

The outer surface of a cylinder is understood to mean that surface of a cylinder and/or roller to which a first metal layer is applied. In the context of the present application, on the other hand, the surface of the cylinder is understood to mean the outer, generally cylinder-shell-shaped boundary surface of the outermost metal layer.

The outer surface is therefore formed by the base body of the cylinder. The base material of the base body of the cylinder and/or roller is preferably in a form such that a ductile metallic matrix adheres to it. This is generally achieved for conventional cylinders and the base bodies thereof.

All particles which have a higher hardness than the ductile metallic matrix can preferably be used as the hard material particles. The selection of the hard material particles may depend, in particular, on the intended field of use or application for the cylinder and/or roller.

By way of example, it is therefore possible to provide different hard material particles for cylinders used in the paper and/or printing industry than for a coating of a cylinder used for processing metal. This applies analogously for rollers. By way of example, drive rollers for conveyor belts, for example for conveying raw material, are exposed to a different wear potential than, for example, a deflection roller for metal material in a rolling mill. The type of hard material particles to be used can therefore be selected depending on the wear to be expected on the roller and/or cylinder.

A plurality of metal layers having different properties may also be applied to a cylinder and/or roller. It is also possible to combine different types of hard material particles with one another in one layer.

The expenditure for repairing the cylinder and/or roller is therefore reduced by firstly reducing the expenditure for producing the coating. Furthermore, the reduced wear on the cylinder and/or roller increases the operating times and reduces the shutdown times. In addition, a wear-reducing and/or corrosion-reducing layer is provided, in which case no further surface treatment measures are required in order to reduce the wear and/or corrosion on the cylinder after the metal layer has been applied.

According to an embodiment, hard material particles are formed by at least one element from the group consisting of carbides, in particular boron carbide, tungsten carbide or silicon carbide, or aluminum titanate or carbon modifications, in particular diamond, carbon nanotubes or graphite, or zirconium oxide. Particles formed from such material have already proved to be suitable in tests and are suitable for incorporation in the form of hard material particles in a ductile metallic matrix. The use of an element from the group consisting of carbides, in particular boron carbide, tungsten carbide or silicon carbide, or carbon modifications, in particular diamond, carbon nanotubes or graphite, or zirconium oxide or aluminum titanate makes it possible to greatly reduce the wear on the surface of a cylinder and/or roller. In particular, it is also possible to use other carbon modifications distinguished by a high hardness, for instance fullerenes. The hard material particles preferably have a higher Vickers hardness than the ductile metallic matrix, in particular a Vickers hardness greater than substantially 180 HV₀₁.

It is advantageous if the ductile metallic matrix is substantially in the form of a nickel matrix. It is also advantageously possible to use a nickel alloy matrix as the ductile metallic matrix. By way of example, cobalt and/or iron may be provided as a nickel alloy constituent.

The abovementioned hard material particles, in particular, have good solubility in a nickel or nickel alloy matrix, and so it is possible to produce, for example, homogeneous layer properties without technical problems—for instance owing to segregation. The selection of the material which forms the basis of the matrix makes it possible to set layer properties, for example the ductility.

According to an embodiment, hard material particles to be introduced into the metal layer are covered with a coating of hard material particles. A coating of hard material particles which is applied to the hard material particles before the metal layer is applied to a cylinder and/or roller makes it possible to use hard material particles which cannot be introduced, in particular electrolytically, into a metallic matrix without a coating, for example zirconium oxide. This makes it possible to considerably increase the number of possible hard material particles which can be used, as a result of which a person skilled in the art is able to use hard material particles which can be selected specifically for his purposes. It is advantageous that the coating of hard material particles consists of the same material as the metallic matrix into which the coated hard material particles are intended to be introduced. A material which increases the solubility and/or activation of the hard material particles in the metallic matrix may be used, in particular, for the coating of hard material particles.

According to a further embodiment, the ductile metallic matrix has a predefinable density distribution of incorporated hard material particles. This makes it possible to arbitrarily set the property of the coating to the field of use and the materials to be processed using the cylinder and/or roller. In this case, the predefinable density distributions discussed may be line densities, surface densities or volume densities of hard material particles in the metal layer.

An example of a line density may be, for example, a concentration gradient of the surface density of the hard material particles over the layer thickness of the deposited metal layer. When there is a constant surface density within each portion of the layer thickness, this involves a radially symmetrical distribution which may be characterized by the concentration of the hard material particles as a function of the radius. By way of example, the first metal layer deposited on the outer surface may have the highest content of hard material particles in order, for example when the repair measure is delayed, not to put the outer surface of the cylinder and/or roller at risk, whereas the concentration of the hard material particles decreases linearly or non-linearly down to a suitable limit value radially to the outside. Step functions which characterize the distribution of the hard material particles are also conceivable as a line density in the distribution of the hard material particles over the radius of the cylinder and/or roller.

An example of a surface density may be, for example, the increase in the concentration of the hard material particles in a for example annular surface portion of the outer surface of the cylinder and/or roller which is exposed to greater loading than other areas of the surface of the cylinder and/or roller. It is advantageous in the case of such areas of the surface with high expected loading to locally adapt the density of the hard material particles, for example to increase it, in order to achieve uniform wear on the surface despite different local loading of the surface. As a result, the surface of the cylinder is worn uniformly and the profile of the cylinder—when considering the cylinder profile in relative terms—remains stable over time.

Volume density may be understood to mean both a local volume density and also the mean volume density. This applies analogously also for the surface density and line density. The mean volume density is the volume proportion of the hard material particles in the entire metal layer compared with the overall volume of this metal layer. However, this does not mean that the specification of a mean volume density always results in a uniform distribution of the hard material particles in the metal layer. Rather, locally large deviations from a mean volume density of the hard material particles may arise owing to an increased or reduced local volume density of the hard material particles.

According to an embodiment, the ductile metallic matrix has a mean volume density of incorporated hard material particles of substantially at most 40% by volume. As the proportion of the hard material particles in the metal layer increases, the metal layer becomes increasingly more brittle. The accumulation of hard material particles in the layer may result in predetermined breaking points since the hard material particles in these accumulations are no longer completely surrounded by a ductile matrix, but instead make contact with one another. When the metal layer is subjected to permanent and high loading, this may lead to fractures, in particular microcracks, in the metal layer. This in turn may result in portions of the metal layer breaking off if a plurality of microcracks converge. It is therefore advantageous if the mean volume density of the hard material particles does not exceed substantially 40% by volume.

It is particularly advantageous to provide the hard material particles in a range of from 8% by volume to 25% by volume in the metal layer. This then produces a proportion of the ductile matrix of 92% by volume to 75% by volume. A composition of the metal layer in said range makes it possible to greatly reduce the wear on the cylinder and/or roller, accompanied by a low degree of brittleness of the metal layer.

A metal layer containing a ductile nickel alloy having incorporated hard material particles which are preferably distributed homogeneously is particularly advantageous. It is advantageously possible to use a layer thickness of 1 μm to 100 μm, preferably 2 μm to 50 μm or 5 μm to 20 μm. The volume proportion of the hard material particles in the metal layer is advantageously 1% to 40%, preferably 2% to 15% or 4% to 12%. The particle size of the hard material particles is advantageously selected in the range from 0.1 μm to 5 μm, preferably 0.5 μm to 3 μm or 0.8 μm to 2 μm. The hard material particles advantageously consist of boron carbide, diamond, tungsten carbide or zirconium oxide, in which case mixtures of in each case two of these materials are also advantageous, particularly when using a multiple coating, in particular a dual coating, of the cylinder and/or roller. This makes it possible to multiply the service lives while keeping the coating costs per cylinder and/or roller the same and makes it possible to maintain the roll camber within the permitted tolerances for a longer period of time. These advantages also result in an increase in the availability of the installation and in the yearly productivity of the installation owing to a reduced number of cylinder and/or roller changes.

A coating is preferably applied to the cylinder and/or roller in such a way that, when the metal layer applied is worn, the coefficient of friction remains constant, in particular locally, despite the wear. This makes it possible to carry out a constant procedure for industrial installations, for example for steel mills, in particular casting installations with guide rollers, for rolling mills, for installations in the paper and printing industry or textile industry, independently of the wear on the cylinders and/or rollers, if the metal layer has not been completely worn off as a result of wear. On the other hand, it is also possible to predefine a predefinable coefficient of friction profile over the thickness of the metal layer with increasing abrasion.

According to a further embodiment, the ductile metallic matrix has a predefinable grain size distribution of incorporated hard material particles. The setting of a predefinable grain size distribution makes it possible to vary the coefficient of friction from roller to roller or from cylinder to cylinder, but also locally on a roller or on a cylinder. This allows the process to be highly flexible when adapting the metal layer for a specific application. The predefinable grain size distribution may be achieved, for example, by providing hard material particles having a specific grain size or a grain size distribution for applying the metal layer, for example in an electrolysis bath. By way of example, the grain sizes of the hard material particles may be distributed radially in the metal layer by setting the concentration of the hard material particles in an electrolysis bath. For this purpose, it can be provided that hard material particles having different grain sizes or grain size distributions are supplied successively to the electrolysis bath during the electrolysis in such a manner that a specific radial grain size distribution is set in the metal layer.

According to an embodiment, a plurality of metal layers are applied to the outer surface on top of one another, wherein adjoining metal layers have different colors. In principle, each metal layer has a natural color which it obtains after it is produced, without further treatments having been carried out. By way of example, the color may also be determined by the hard material particles incorporated in the metal layer since different hard material particles in the ductile metallic matrix have different optical properties. In this respect, if suitable hard material particles are selected, it is optionally possible for two adjoining metal layers to therefore have different colors because different hard material particles are used for each of these two metal layers.

The coloring may also be achieved in any other desired way. However, it is preferable to select a coloring process for the metal layer such that the color is preferably uniformly present throughout the respective metal layer.

Colored particles are preferably incorporated in the ductile metallic matrix. It is possible to apply a plurality of, i.e. at least two, metal layers to the cylinder and/or roller, with adjoining colored layers having different colors. This may be achieved, for example, by adding colored particles to at least one of the two metal layers.

The different coloring of two adjoining metal layers makes it possible to notice wear on a cylinder surface and/or roller surface formed by the metal layers since the wear causes a change in color at the transition from an outer metal layer to an adjoining metal layer. In this case, the metal layers may have identical properties apart from the color.

If a newly coated cylinder has a plurality of metal layers, in which case adjoining metal layers differ in color, it can be established when at least portions of the upper layer of the metal layers have become worn. This may be a measure that recoating of the cylinder is necessary within a specific time. The colors of adjoining metal layers are preferably selected so as to be different, for instance yellow and blue, red and blue or red and green, preferably complementary colors. As an alternative, for example, it is possible to use colors used in other technical fields, for example green, yellow and red (from the field of traffic), in order to signal the state in which the cylinder and/or roller is.

It is also possible to provide a metal layer system comprising a large number of metal layers, in which each color of one metal layer differs from the respective other color of the other metal layers in the metal layer system. The number of metal layers within the metal layer system may become very large when the layer thickness of the individual metal layers is small. If all the metal layers within the metal layer system have different colors, it is possible to visualize a wear profile or roughness profile of the cylinder or roller by operating the cylinder and/or roller. On this basis, it is then possible for the cylinder and/or roller to be recoated, for example. In this case, it may be provided that a density of hard material particles adapted to the local loading of the cylinder and/or roller is applied during recoating to points with a high degree of wear, i.e. high abrasion of the metal layer system down to a low metal layer, in which case the depth of the abrasion can be determined by means of the exposed color.

The cylinders may advantageously be in the form of casting cylinders, working cylinders, back-up cylinders and dressing cylinders for industrial installations for processing metal material, in particular casting installations and rolling mills. By way of example, rollers may be in the form of guide rollers, transport rollers or deflection rollers. This also includes guide cylinders and deflection cylinders. The application is also intended to include all further cylinders and/or rollers which are exposed to high mechanical and/or thermal loading.

Owing to the good thermal conductivity and thermal stability of the metal layer, it is possible to use rollers and cylinders even at high temperatures, in particular during hot rolling and casting.

Therefore, the rollers produced according to various embodiments can advantageously be used as guide rollers and/or as deflection rollers, in particular for use in metal-processing industrial installations.

In terms of the process, the object is achieved by means of a process for the production and/or repair of a cylinder and/or roller, wherein a metal layer is applied to at least portions of an outer surface of the cylinder and/or roller. Since a ductile metallic matrix having incorporated hard material particles is used as the metal layer, the layer may be reapplied after wear, as a result of which the service life of a cylinder is increased considerably.

According to an embodiment, when the metal layer is being applied, the cylinder is rotated about its axis of rotation in relation to means for applying the metal layer. The means for applying the metal layer are generally designed in such a way that a specific process is used for applying the metal layer to the outer surface of the cylinders and/or rollers. In this process, the means for applying the metal layer may either move about the cylinder and/or roller such that at least portions of their outer surface are coated or, as an alternative, it is generally easier to rotate the cylinder and/or the roller about their respective longitudinal axis during the coating process. This is advantageous since the longitudinal axis of a rotationally symmetrical body, in this case a cylinder or a roller, is rotated about its axis with the smallest moment of inertia. Accordingly, a relatively small force or motor power is required in order to rotate the cylinder and/or roller. If appropriate, it is also possible to carry out a combined movement of cylinder and means for applying the metal layer. According to an embodiment, the ductile metallic matrix having the incorporated hard material particles is applied by means of electrolysis. For this purpose, the cylinder and/or roller is generally arranged at least partially in an electrolysis bath. Certain portions of the outer surface of the cylinder are therefore immersed in an electrolyte. A voltage is applied to the cylinder such that metal ions located in the electrolysis bath, for example nickel ions, are deposited on the outer surface of the cylinder. For this purpose, at least one metal electrode, for example a nickel electrode, is arranged in the electrolysis bath.

During the deposition process of the metal ions, the hard material particles are guided onto the outer surface of the cylinder and/or roller by means of an air flow or by means of a flow of liquid. By way of example, this may be achieved in that the hard material particles are already present in the electrolyte and are guided onto the outer surface by the flow.

Alternatively, the hard material particles may be introduced into the electrolysis bath by the means which form the flow. A low-cost way of providing the metal ions is to provide a corresponding metal electrode in the electrolysis bath from which metal ions go into solution. In this case, use may be made in particular of a nickel electrode to which a positive voltage is applied.

The use of an air flow or a flow of liquid means that the hard material particles flow around at least portions of the outer surface of the cylinder and/or roller and as a result hard material particles are incorporated in the metallic matrix which is deposited when nickel is electrochemically precipitated on the outer surface of the cylinder and/or roller. The air flow or the flow of liquid, which guides the hard material particles onto the outer surface, has a decisive influence on the incorporation of the hard material particles. The electrolyte from which the ductile metallic matrix is deposited is of a form such that cations in the form of the desired metal ions are firstly deposited from the solution in the context of the electrochemical potential series.

The flow rate of the air flow or of the flow of liquid and also the concentration of hard material particles in the air flow or in the flow of liquid, inter alia, are decisive for the properties of the layer deposited on the outer surface. In this respect, the use of an air flow in the electrolysis bath is disadvantageous since bubbles which rise on the outer surface of the cylinder and contain hard material particles can be controlled only with difficulty. In the case of high-quality, individually set layers, use is generally made of a flow of liquid, in which case the hard material particles are already present in the electrolysis bath.

Electrolysis makes it possible to deposit layers of a few micrometers up to millimeters or more. Therefore, the layer thickness is virtually freely selectable. At the same time, electrolysis makes it possible to achieve a very high degree of accuracy when setting the layer thickness.

The object of reducing the expenditure for repairing the cylinder and/or roller is likewise achieved by means of a device for monitoring the wear on a cylinder and/or roller which is subjected to wear on its surface and is produced as claimed in claim 11 or 12, comprising a detector for detecting a change in color on the surface. The basis for monitoring the wear in this case is the detection of the change from a first color to a second color. In this case, it is not absolutely necessary for the color of the surface to be detected. It only has to be possible to detect the change from a first color state to a second color state. This makes it possible to detect when a cylinder and/or roller is worn to such an extent that it is necessary to replace the affected cylinder and/or roller. The process increases the operational safety since it is possible to detect wear on a cylinder and/or roller reliably, continuously and without any risk to people. It also improves the ability to plan cylinder changes and/or roller changes. A camera or a color sensor, for example, may be provided as the detector. The detector is preferably operatively connected to a device for detecting the change in color, generally a data processing device.

It is also advantageous that the detector detects a change in color by detecting the color of the metal layer. As a result, the realization that a cylinder and/or a roller is becoming worn is not restricted to the period of time of the change in color; rather, the state of the cylinder and/or roller can be detected at any time. A color echelon of colored metal layers applied to a cylinder and/or roller, which echelon is assigned to the wear, is preferably stored in a programmable unit such that, when a color is detected, it is always possible to indicate whether the cylinder and/or roller has a critical or uncritical wear state. This can be performed, for example, by a data processing device mentioned above.

Another embodiment provides a device for emitting a signal when a change in color has been detected. By way of example, the signal can be supplied to a central control device which then displays information corresponding to the signal on a screen in a monitoring space or monitoring control center. The signal may likewise be supplied to a remote service control center, likewise a monitoring control center, which uses the signal to draw up, for example, a service order for a specific cylinder and/or a roller in the affected industrial installation.

In particular, it is advantageous that it is additionally possible to use the detector to identify a cylinder and/or roller which has the detected wear phenomena. This can be done, for example, by assigning each roller precisely one detector which, in addition to the color or a change in color, always also concomitantly supplies a separate identifier as a constituent of the signal, or else an identifier of the roller which can be detected by the detector is also detected.

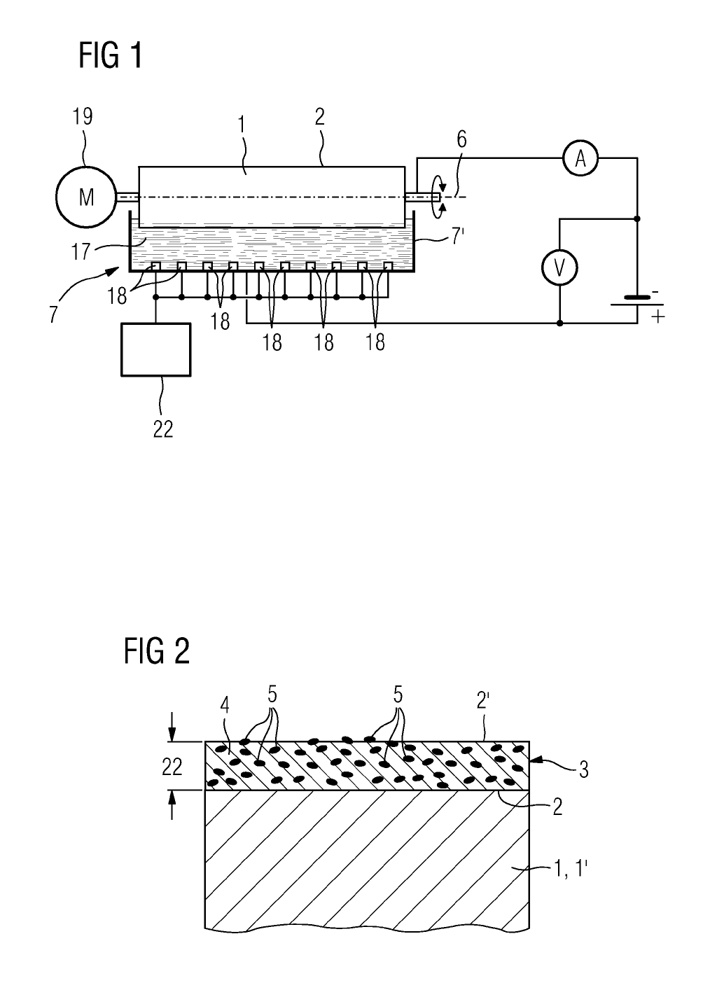

FIG. 1 shows an electrolysis device 7 for producing a metal layer according to various embodiments on a cylinder 1. In this case, the metal layer to be applied is in the form of a ductile metallic matrix having incorporated hard material particles. In order to apply a metal layer of this type to an outer surface 2 of the cylinder 1, a portion of the outer surface 2 of the cylinder 1 is arranged in a tank 7′ of the electrolysis device 7. The tank 7′ is filled with a nickel-containing electrolyte 17 which is preferably in the form of an aqueous solution. Certain sections of the outer surface 2 of the cylinder 1 are immersed in this electrolyte 17. In order to deposit a uniform ductile metallic matrix on the cylinder 1, a motor 19 which drives the cylinder 1 in such a way that the latter rotates about its axis of rotation 6 is provided. In this process, part of the outer surface 2 is continuously introduced into the nickel-containing electrolyte 17 and, at the same time, part of the outer surface 2 is removed from the electrolyte 17 at a different location. The setting of the rotational speed of the cylinder 1 about its axis of rotation 6 may be used to set the layer properties of the metal layer to be deposited, for example to set a concentration gradient of the hard material particles over the thickness of the metal layer.

Furthermore, a negative voltage is applied to at least the outer surface 2 of the cylinder 1, such that the nickel ions dissolved in the electrolyte 17 precipitate on the outer surface 2 of the cylinder 1. The dissolved nickel ions can be provided in the electrolyte 17 at low cost by means of at least one nickel electrode (not illustrated) which is arranged in the electrolyte 17 and to which a positive voltage is applied. This can be done using the voltage applied to the tank 7′ in FIG. 1.

Furthermore, hard material particles present in the electrolyte 17—in the present case boron carbide—are guided onto the outer surface 2 of the cylinder 1 by means of valves 18 which are present in the tank 7′ and produce a flow of liquid. The flow of liquid can be controlled effectively and guides the hard material particles onto the outer surface 2 of the cylinder 1 in controlled fashion.

As an alternative, the hard material particles can be introduced into the tank 7′ by means of a carrier—for example the flow of liquid or the air flow. The carrier used for the hard material particles is preferably the same electrolyte 17 as the electrolyte 17 present in the tank 7′, and so the guiding of the hard material particles onto the outer surface 2 does not reduce the nickel concentration in the area surrounding the outer surface 2. The deliberate introduction of hard material particles into the electrolysis bath by means of carriers makes it possible to reduce costs since fewer hard material particles are required in order to produce the metal layer.

During the precipitation of the nickel ions from the nickel-containing electrolyte 17 onto the outer surface 2—on account of the electrical voltage applied to the outer surface 2—the hard material particles guided onto the outer surface 2—boron carbide—are incorporated in the nickel matrix when the latter is deposited.

The concentration and the density of the hard material particles in the nickel matrix can be set by means of the flow rate of the flow of liquid which guides the hard material particles onto the outer surface 2 and by means of the concentration of the hard material particles in the flow of liquid.

The use of a carrier which introduces the hard material particles into the electrolysis bath by means of the valves 18 also makes it possible to introduce different concentrations of hard material particles from valve 18 to valve 18. As a result, it is possible to set a different predefinable density distribution of the hard material particles along the axis of rotation 6. Means which prevent carrier flows from adjacent valves 18 from mixing together, which leads to an undesirable deviation of the density distribution of the hard material particles from the predefined density distribution, are preferably provided.

Such setting of a predefinable density distribution of the hard material particles in the metal layer should generally be adapted to the field of use and the specific use of the cylinder 1. This applies analogously to rollers.

The voltage applied to the cylinder 1 or to the outer surface 2 and the preferably continuous rotation of this cylinder about its axis of rotation 6 produce a uniform deposition of a nickel matrix with a layer thickness essentially determined by the duration of the electrolysis. The electrolysis makes it possible to apply and precisely set layer thicknesses of the metal layer in an order of magnitude of a few micrometers to several millimeters or more to the outer surface 2 of the cylinder 1. After the electrolysis has ended and the cylinder 1 has been removed from the tank 7′, the cylinder 1 then has a surface formed by the applied metal layer. This considerably reduces the wear on the cylinder 1 when processing a rolling material such as metal, paper or textiles.

FIG. 2 shows an excerpt from the side of a cylinder 1 or roller 1′ coated with a metal layer 3. The metal layer 3 has a layer thickness 22. The metal layer 3 deposited on the outer surface 2 of the cylinder 1 or roller 1′ comprises hard material particles 5. The density distribution of the hard material particles 5 and the grain size distribution of the hard material particles 5 can be predefined and set. The hard material particles 5 are incorporated in a ductile metallic matrix 4. Hard material particles 5 or clusters of hard material particles are preferably completely surrounded by the ductile metallic matrix 4. Despite being worn in the middle, a metal layer 3 illustrated in FIG. 2 leads to a constant coefficient of friction when the metal layer 3 erodes over the layer thickness 22 of the metal layer 3.

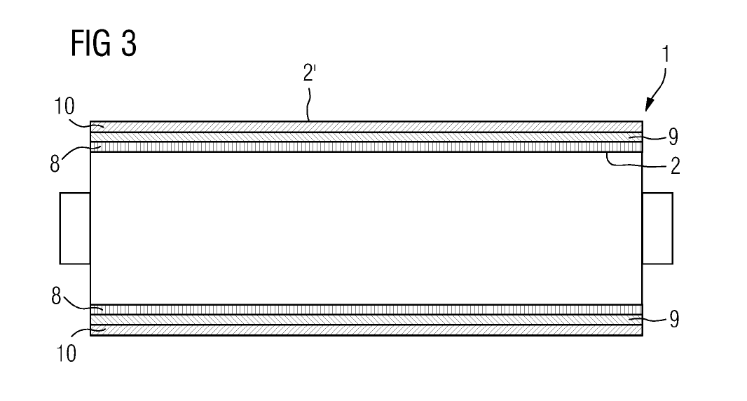

FIG. 3 shows a sectional illustration through a cylinder 1 on which a plurality of metal layers 8, 9, 10 each with different colors are deposited. The different colors are indicated by different hatchings. In the case of the cylinder 1 shown, the first metal layer 8 was applied, for example by means of electrolysis, with a first color to the outer surface 2 of the cylinder 1. A second metal layer 9 was applied on top, for example likewise by means of electrolysis, with a second color different from the first. A third metal layer 10 with a third color different from the first and second colors was applied on top of said second metal layer 9. A cylinder 1 coated in this way firstly makes it possible to achieve a considerably increased service life without having to replace the cylinder. Secondly, the color of the surface makes it possible to establish how far wear on the surface of the cylinder has progressed.

In FIG. 3, the first color of the first metal layer 8 is red, the second color of the second metal layer 9 is yellow and the third color of the third metal layer 10, and hence the metal layer which forms the surface 2′ when the recoated cylinder is commissioned, is green. The operation of the cylinder 1 or a roller coated in this way then results in wear phenomena on the surface 2′ of the cylinder 1, but this can be considerably reduced by the metal layers. At some stage, the erosion of the metal layers 8, 9, 10 caused during operation therefore results in a local or areal change in the color of the surface 2′ of the cylinder 1, and this makes it possible to determine how and to what extent wear occurs on the cylinder surface.

It is possible to establish when a change in color occurs, for example from green to yellow, and this signals that at least parts of the outermost metal layer 10 have been eroded. On the basis of this finding, it is then possible, for example, to draw up a service order in order to repair the cylinder 1, but without having to cease the operation of the cylinder momentarily.

The first metal layer 8 of the cylinder 1, the red metal layer in the exemplary embodiment, may be provided as an emergency buffer if repair cannot be carried out in good time—when the second metal layer 9 is becoming worn. This makes it possible to prevent shutdown times of the industrial installation owing to delayed repair and to prevent possible significant damage to the cylinder 1, in particular the base body of the cylinder 1, when operation is continued despite wear on the surface. This may be important, in particular, for carrying out roll grinding.

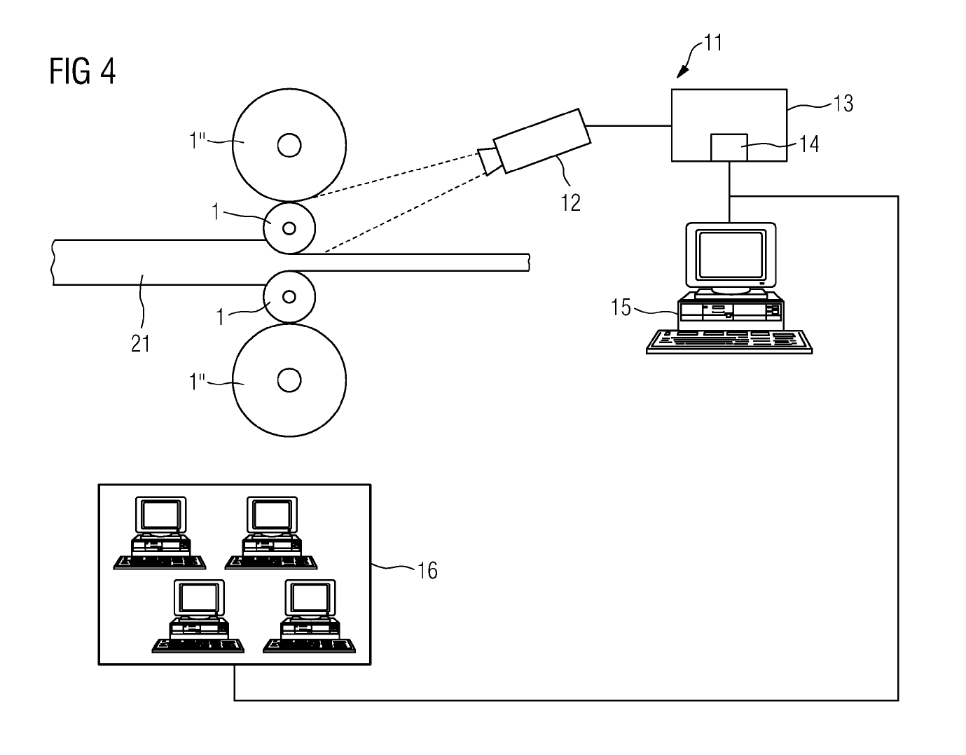

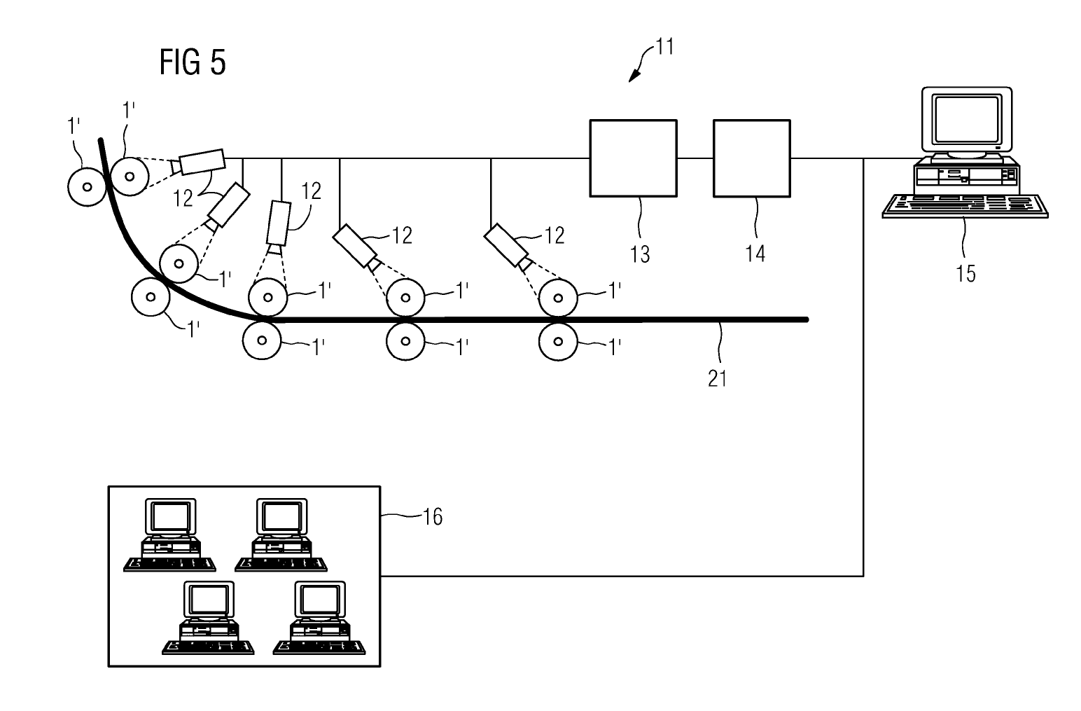

FIG. 4 shows a device 11 for monitoring the wear on a working cylinder 1 for rolling a metal material 21. The working cylinders 1 are supported by back-up cylinders 1″. At least the upper working cylinder 1 has at least two metal layers (not illustrated) with different colors. In this case, the outermost metal layer forms the surface of the working cylinder 1. The rolling of metal material 21 by the working cylinders 1 causes wear on the surface of the working cylinder 1. This wear is monitored by means of a detector 12 which is arranged so as to be able to detect the color of the surface of the working cylinder 1.

The detector 12 emits a signal which is assigned to the detected color and is supplied to a detection device 13. The detection device 13 detects both the color of the surface of the working cylinder 1 and also whether the color has changed at least in one portion of the surface of the working cylinder 1. A signaling device 14, which is part of the detection device 13, is used to transmit the state of the surface of the working cylinder 1 to an output unit in a monitoring space 15.

At the same time, the signal produced by the signaling device 14 is transmitted to a service station 16. The service station is generally assigned to a company which repairs the cylinders 1 and/or rollers 1′ coated in this way (see FIG. 5). Furthermore, a large amount of information such as this is received at the service center 16 from different industrial installations.

The color or a change in color of the surface of a working cylinder 1 can be detected not only for the roll stand shown in FIG. 4 but also for a large number of further rollers and roll stands or cylinders, for example also for back-up cylinders 1″. A device 11 of this type for monitoring wear on cylinders and rollers makes it possible for both the repairman and the operator of the industrial installation to always be up to date regarding the state of wear on the working means.

FIG. 5 shows part of a casting installation in which a metal material 21 in the form of a train is guided through a plurality of guide rollers 1′. At least some of the guide rollers 1′ are coated with at least two metal layers having different colors. This firstly reduces the wear on the surface of the rollers 1′ and secondly makes it possible to determine a state of wear on the rollers 1′.

FIG. 5 shows a plurality of detectors 12 assigned to the upper, generally driven rollers 1′. These detectors 12 each detect a color of the surface of that roller 1′ to which they are assigned. A signal assigned to the detected color of the surface of the rollers 1′ is supplied to a detection device 13. The detection device 13 detects the state of wear of the surface of the detected rollers 1′ by detecting the color of said surface.

By way of example, the color can be detected by means of reference signals which are stored in the detection device 13 and are each assigned to a color. Signals assigned to the detected colors of the respective surface of the rollers 1′ are supplied to a signaling device 14 which emits a signal to output the detected colors or a change in color to an output unit. The output unit is preferably part of the central monitoring space 15 of the industrial installation. If the color of a roller 1′ changes, not only is the monitoring space 15 informed by the signaling device, but also a signal is sent to a remote service center 16, and so this center is informed of a prompt repair measure.

All cylinders 1 or rollers 1′ which are subjected to wear and have a coating of this type, i.e. at least two metal layers having different colors, are preferably monitored by such a device 11 for monitoring wear. This makes it possible to reduce shutdown times, to increase productivity and to optimize repair measures.

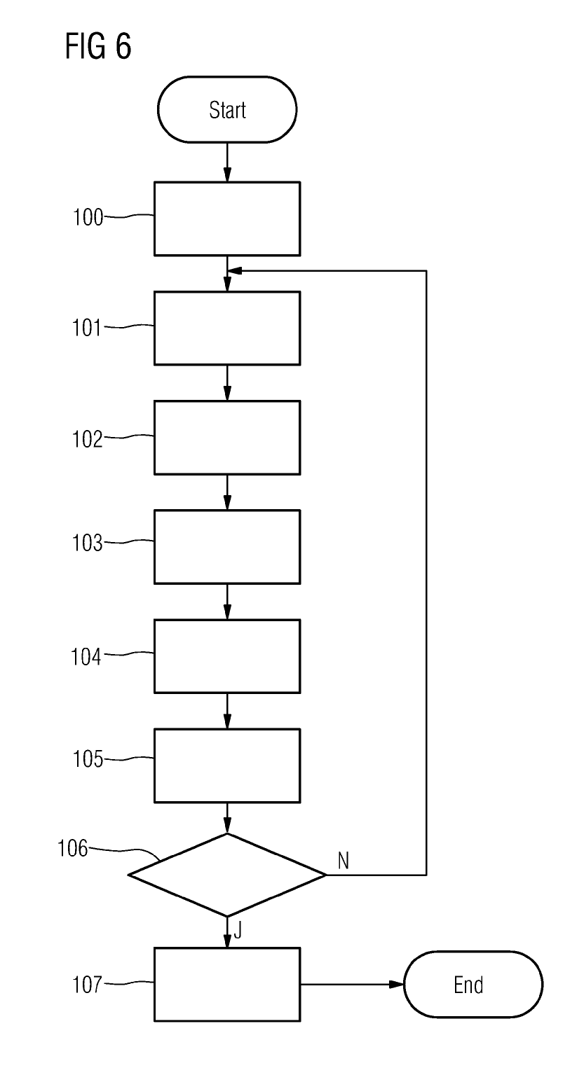

FIG. 6 shows a flowchart for a process for the production of a cylinder. The process relates to the production of a metal layer for a cylinder, wherein the metal layer comprises a ductile metallic matrix, in this case a nickel matrix, having incorporated boron carbide particles.

The flowchart shown in FIG. 6 assumes that the metal layer is applied to the outer surface of the cylinder by means of electrolysis. In this case, the cylinder is already arranged in a tank in such a way that at least portions of the outer surface are immersed in a nickel-containing electrolyte solution. In the first process step 100, the cylinder is rotated about its axis of rotation. The layer parameters for the metal layer to be deposited on the cylinder are then set. First of all, a density distribution of the hard material particles for the metal layer is set, taking into account the field of use of the cylinder or of the roller to be coated. This takes place in process step 101. A grain size of the hard material particles is then established in process step 102, likewise taking into account the field of use of the cylinder or roller. The grain size and the density distribution of the hard material particles can be varied locally over the outer surface of the cylinder or roller.

A desired coefficient of friction or a coefficient of friction distribution, which the metal layer should have with respect to a material to be processed, is advantageously predefined in order for the cylinder operator to set the grain size and the density distribution. In the next process step 103, the supply of hard material particles is set. By way of example, this relates to the type of hard material particles to be used, the parameters for guiding the hard material particles onto the outer surface of the cylinder and the concentration of the hard material particles which are guided onto the outer surface of the cylinder in the carrier flow.

In a further process step 104, the color which a metal layer should have is set. Accordingly, colored particles are mixed in during the supply of hard material particles, and these colored particles are then also incorporated in the nickel matrix during the electrolysis.

Furthermore, in process step 105, a layer thickness of the metal layer to be deposited on the outer surface of the cylinder is predefined. This is also based on the field of use of the cylinder or roller.

In process step 106, it is questioned whether further metal layers should be deposited on said first metal layer. The properties of the metal layers which follow the first metal layer, if these layers are provided, can be selected independently of the layer properties of the first layer. After the parameters for the desired metal layers on the outer surface of the cylinder have been established, the electrolysis is started and carried out in process step 107. For this purpose, voltage is applied to the rotating cylinder and the hard material particles are guided onto the outer surface of the cylinder according to the settings.

The entire process for the production of the metal layer, in particular the set grain sizes, the set density distribution, the set supply of hard material particles and supply of colored particles, is preferably controlled by means of a control device. This makes it possible to coat a cylinder or roller for a specific intended use with high process reliability, as desired by the operator.

FIG. 6 shows an example of a possibility for the production of a metal layer for cylinders and/or rollers. However, it is also possible to use other coating processes, for example powder coating, in particular cold spraying processes, for the production of a metal layer for cylinders and/or rollers.

What is claimed is:

1. A cylinder and/or roller comprising an outer surface, wherein a metal layer is applied to at least portions of the outer surface, and
wherein the metal layer is in the form of a ductile metallic matrix having incorporated hard material particles.

2. The cylinder and/or roller according to claim 1,
wherein the hard material particles are formed by an element from the group consisting of carbides or carbon modifications.

3. The cylinder and/or roller according to claim 1,
wherein,
the ductile metallic matrix contains nickel.

4. The cylinder and/or roller according to claim 1,
wherein
the ductile metallic matrix contains cobalt.

5. The cylinder and/or roller according to claim 1,
wherein
hard material particles to be introduced into the metal layer are covered with a coating.

6. The cylinder and/or roller according to claim 1,
wherein
the ductile metallic matrix has a predefinable density distribution of incorporated hard material particles.

7. The cylinder and/or roller according to claim 6,
wherein
the ductile metallic matrix has a mean volume density of incorporated hard material particles of substantially at most 40% by volume.

8. The cylinder and/or roller according to claim 1,
wherein
the ductile metallic matrix has a predefinable grain size distribution of incorporated hard material particles.

9. The cylinder and/or roller according to claim 1,
wherein
a plurality of metal layers are applied to the outer surface on top of one another, wherein adjoining metal layers have different colors.

10. The cylinder and/or roller according to claim 1,
wherein
colored particles are incorporated in the ductile metallic matrix.

11. The cylinder according to claim 1,
wherein
said cylinder is in the form of a working cylinder, a back-up cylinder, a dressing cylinder or a guide roller in particular a deflection roller.

12. A process for the production and/or repair of a cylinder and/or roller, the process comprising the step of: applying a metal layer to at least portions of an outer surface of the cylinder and/or roller, wherein
a ductile metallic matrix having incorporated hard material particles is used as the metal layer.

13. The process according to claim 12,
wherein when the metal layer is being applied, the cylinder is rotated about its axis of rotation in relation to means for applying the metal layer.

14. The process according to claim 12,
wherein
the ductile metallic matrix having the incorporated hard material particles is applied by means of electrolysis.

15. A device for monitoring the wear on a cylinder and/or roller which is subjected to wear on its surface, comprising a detector for detecting a change in color on the surface, wherein the cylinder and/or roller comprises an outer surface, wherein a metal layer is applied to portions of the outer surface, and
wherein the metal layer is in the form of a ductile metallic matrix having incorporated hard material particles.

16. The device according to claim 15,
wherein
the detector detects the color of the metal layer.

17. The device according to claim 15,
comprising
a device for emitting a signal at least when a change in color has been detected.

18. The device according to claim 17,
comprising
a monitoring control center to which the signal can be supplied.

19. The cylinder and/or roller according to claim 2,
wherein the element from the group consisting of carbides is boron carbide, tungsten carbide or silicon carbide, or aluminum titanate.

20. The cylinder and/or roller according to claim 2,
wherein the element from the group consisting of carbon modifications is diamond, carbon nanotubes or graphite, or zirconium oxide.
